(19) United States
(12) Patent Application Publication
(10) Pub. No.: US 2019/0321796 A1
(43) Pub. Date: Oct. 24, 2019

(54) SOLID CLEANING PRODUCT, PRODUCT PROCESSING MACHINE AND METHOD

(71) Applicant: Wade Barrineau, North Charleston, SC (US)

(72) Inventor: Wade Barrineau, North Charleston, SC (US)

(21) Appl. No.: 16/388,598

(22) Filed: Apr. 18, 2019

Related U.S. Application Data
(60) Provisional application No. 62/660,516, filed on Apr. 20, 2018.
(60) Provisional application No. 62/668,323, filed on May 8, 2018.

(51) Int. Cl. B01F 13/00; A47K 5/08

(52) U.S. Cl. CPC B01F 13/0018; B01F 7/0025; A47K 5/08

(57) ABSTRACT

A device and method for processing solid cleaning product into solution. A drum has a plurality of canisters. Each canister has a top opening and a lower opening. A plate is positioned below the drum. The plate has an orifice therein. The drum and lower plate are in a rotational relationship to progressively align the lower opening of each canister with the orifice in the plate. A mixing tank is positioned below the drum. The mixing tank receives a sleeve of solid cleaning product gravitationally transported from a canister of the drum through the orifice of the lower plate.

The solid cleaning product is mixed with water in the mixing tank. After mixing, the resulting cleaning solution is transported to a holding tank. The process is repeated according to the level of cleaning solution in the holding tank.

### BACKGROUND OF THE INVENTION

Virtually all industrial cleaning products used today are shipped as liquids or liquid concentrates. It is believed that these liquid products comprise between 60 and 95 percent water and other liquids, and typically, are highly corrosive.

Liquid cleaning products are typically shipped in drums or large totes that may contain up to 330 gallons of material. Not only is water the primary ingredient, but special shipping, storage, and handling procedures are typically required because of the corrosive nature of the liquids. Large amounts of vehicle fuel and energy are required to ship product due to the weight associated with the high water and liquid content despite the fact that water is usually available at sites at which the product is used. Further, substantial storage area for warehousing is required for these hazardous products.

Some cleaning products are shipped as loose powders. Powders are easily spilled and are subject to clumping and deterioration due to humid conditions or wet storage rooms at the point of use. These products are typically manually mixed with water by the end user. This process may result in too little or too much powder being used, resulting in waste and/or a cleaning product that performs poorly or, in some cases, is a hazardous product.

There is a need for a cleaning product that avoids the weight and volume of liquid cleaners, and avoids the problems associated with cleaning products in powder form.

### SUMMARY OF THE INVENTION

A device and method for processing solid cleaning product into solution is described. The device comprises a drum having a plurality of canisters. Each canister has a top opening and a lower opening. A plate is positioned below the drum. The plate has an orifice therein. The drum and lower plate are in a rotational relationship to progressively align the lower opening of each canister with the orifice in the plate. A mixing tank is positioned below the drum. The mixing tank receives a sleeve of solid cleaning product gravitationally transported from a canister of the drum through the orifice of the lower plate.

The solid cleaning product is mixed with water in the mixing tank. After mixing, the resulting cleaning solution is transported to a holding tank. The process is repeated according to the level of cleaning solution in the holding tank.

### DESCRIPTION OF THE DRAWINGS

FIG. 1 shows a disk (1) of cleaning product, a sleeve (2) of cleaning product, and a box (3) of sleeves of cleaning product.

FIG. 2 is a perspective view of a machine for processing the cleaning product according to an embodiment of the invention.

FIG. 3 is a perspective view of the machine for processing the cleaning product according taken from a side that is generally opposite the view of FIG. 2.

FIG. 4 is partially sectioned front elevation of the machine of FIG. 2.

FIG. 5 is a top plan view of the machine of FIG. 3.

FIG. 6 is a partially sectioned side elevation of the machine of FIG. 2.

FIG. 7 is a partially sectioned side elevation showing a side of the machine that is opposite the side shown in FIG. 5.

FIG. 8 is an exploded view of the canister drum in isolation.

FIG. 9 is a perspective view of another embodiment of the machine

FIG. 10 is another perspective view of the machine taken from an end that is opposite of FIG. 9

FIG. 11 is a partial view of the machine of FIG. 10.

FIG. 12 is a partial view of the machine of FIG. 10 showing a box containing sleeves of solid cleaning product in the rotator section.

FIG. 13 is a partial view of the machine of FIG. 12 showing the box advanced within the rotator section.

FIG. 14 is a partial view of the machine of FIG. 13 showing the box further advanced within the rotator section.

FIG. 15 is a partial view of the machine of FIG. 13 showing the box emptied of solid cleaning product and removed from the rotator section.

### DESCRIPTION OF EMBODIMENTS OF THE PRESENT INVENTION

A. The Cleaning Product. The cleaning product of the present invention is a powder that is formulated to the user's requirements for use in the apparatus according to the invention. In one embodiment, the product is compressed into unitary solid disks. The individual disks may be such dimensions as are suitable for the application. Typically, a disk 1 for commercial application as contemplated hereby will have a diameter of about 5 cm. to about 8 cm., and a thickness of about 3 cm to about 4.5 cm. The use of a plurality of smaller disks expedites dissolving of the solid material.

In another embodiment, the solid cleaning product is a loose powder. Packaging the powder in water soluble sleeves that are non-porous when dry, and are humidity resistant, overcomes problems associated with shipping a loose powder into high humidity areas.

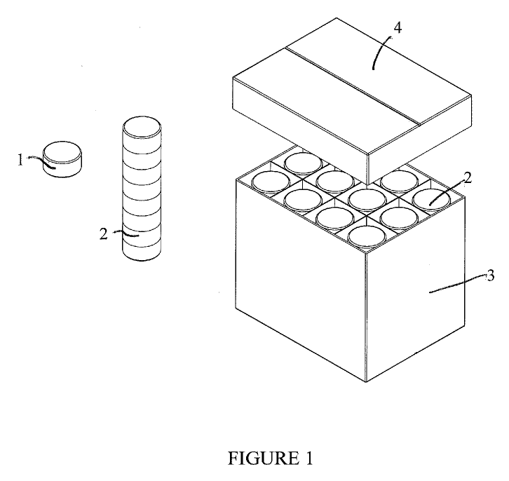

The cleaning product is packaged in a water-soluble sleeve 2 that is preferably non-porous until dissolved in water. FIG. 1. The sleeve is filled with the desired level of cleaning product and is sealed on each end. The packaged sleeve is preferred to have a length of about 25 cm. to about 40 cm. Each sleeve may contain, for example, 6 to 12 disks in one embodiment. The sleeves are preferred to be packaged into a box 3 with multiple dividers, similar to a wine box. The box may have a removable one-piece lid 4 for ease of access. While the sleeves are water soluble, they are resistant to humidity encountered in some locales. The overall weight of the solid cleaning product is determined according to the application.

The box 3 and lid 4 in which the sleeves 2 of solid cleaning product are transported are preferred to have water and moisture retarding characteristics, such as being formed from wax coated or plastic-coated cardboard. Each the sleeve has the proper portion of cleaning product when used with the machine as described herein.

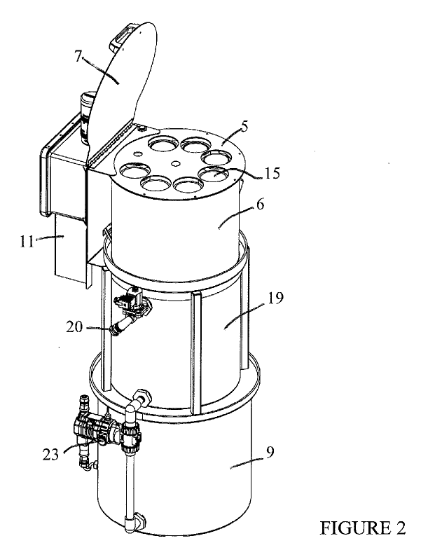

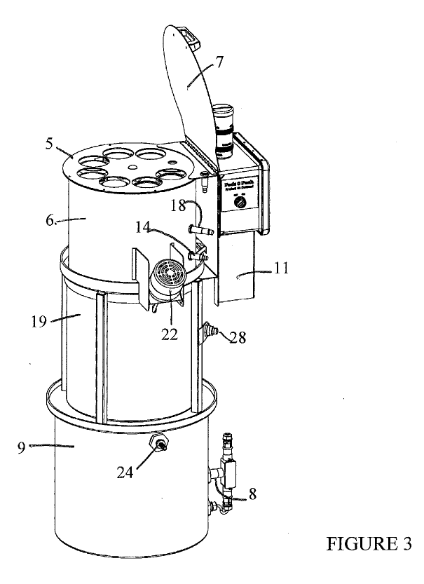

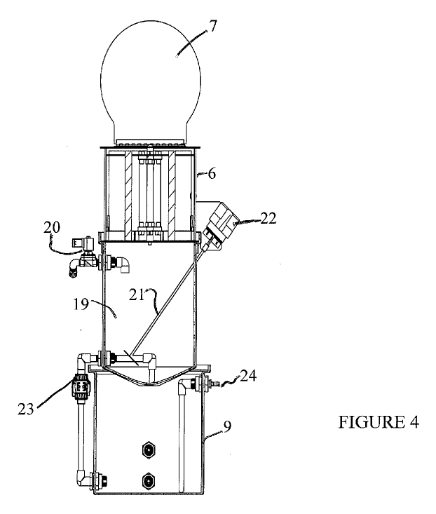

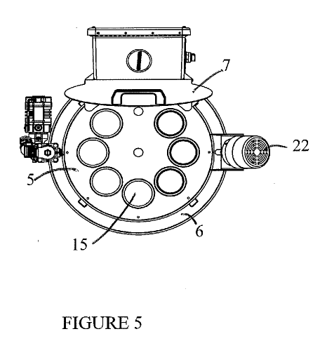

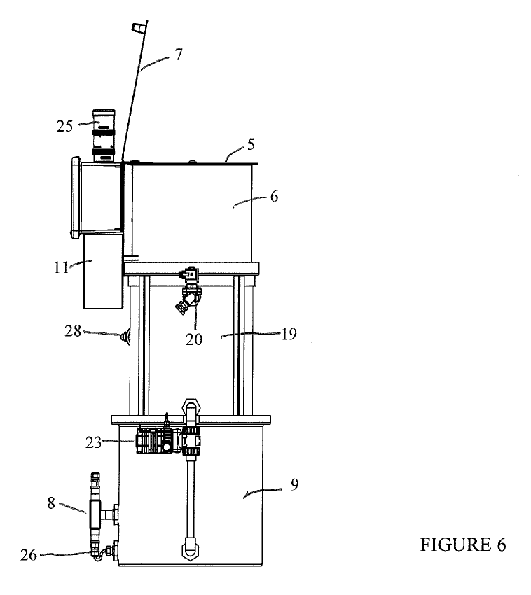

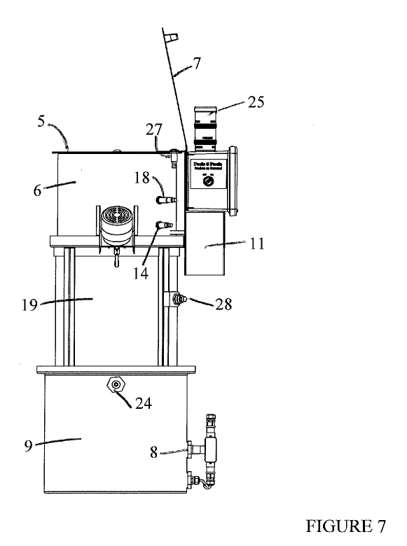

B. The Machine. The cleaning product is packaged and used with an apparatus according to the invention that virtually eliminates problems associated with handing and forming a solid cleaning product into solution. FIGS. 2-8. The sleeves 2 and the apparatus insure proper mixing of the solid cleaning product with water. The machine is preferred to be automated to mix the sleeves of cleaning product with water. The only additional action by the operator in the preferred embodiment is to load the sleeves into canisters in a drum and then dispose of the preferably recyclable cardboard boxes 3 and lids 4 after the boxes are emptied as described herein.

In one embodiment, an operator places one or more sleeves 2 of cleaning product through openings or orifices in stationary or static upper plate 5, shown as located above the canister drum 6 on the top of the machine. Each orifice of the upper plate is positioned over one canister 15 in this embodiment, and each canister accepts one sleeve of cleaning product through the associated orifice. The canisters in the embodiment as shown are hollow cylinders that are constructed and arranged to receive the sleeves of solid cleaning product according to the invention. The canisters are elongated, and in most embodiments, will have a round cross section, but the canisters could have an oval or rectangular or other geometric cross section. Generally, the geometry of the cannisters is determined by the geometry of the sleeves.

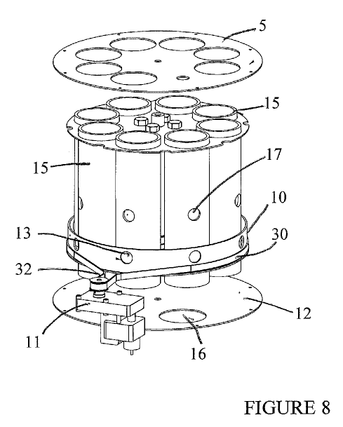

After loading, the operator closes the lid 7 on the machine. If product is called for, as determined by the level sensor 8 in the finished holding tank 9 that senses a remaining volume of cleaning solution, the machine actuates and rotates the canister drum 6. In a preferred embodiment, rotation of the canister drum is accomplished by a synchronous drive belt disposed around the belt ring 10 of the canister. The drive belt 30 is driven by a drive pulley 32 mounted on the gear motor 11 that may be positioned adjacent to the canister drum. FIG. 8.

Preferably, a safety switch or similar mechanism prevents the machine from operating with the lid 7 open. For example, a sensor 27 detects the lid position. The canister drum will not index while sleeves are being loaded into the machine.

In a preferred embodiment, the canister drum is positioned above a stationary lower plate 12 that has a single orifice or opening 16. The opening 16 is sufficiently large to permit a single sleeve 2 of solid cleaning product to drop through the opening by gravity and into the mixing tank 19 below. Opening 16 in the stationary or static lower plate 12 does not have a matching opening in the stationary upper plate 5 above. That is, the upper plate as shown has one less orifice or opening than the number of canisters in the drum, and none of the upper plate orifices is positioned directly over the orifice or opening in the lower plate. This configuration prevents a sleeve of solid cleaning product from being dropped through the upper plate 5 and a canister 15 and directly into the mixing tank 19 by the operator.

In the embodiment as shown in the illustrations, the belt ring 10 has a plurality of ports 13. The number of ports as shown is equal to the number of canisters, with one of the ports 13 associated with one of the canisters 15. A stationary frame mounted position sensor 14 affixed in the same plane as the ports detects the ports 13. This sensor communicates with the controller to determine when an individual canister 15 of the canister drum is aligned with the base opening 16 so that the sleeve contained in the individual canister is positioned to drop through the opening.

Each individual canister 15 in the canister drum is preferred to have an inspection port 17 in its side that is disposed outwardly from the center of the drum. The inspection port may be a void, or a void covered with a material that is transparent to the light emitted by the photo sensor 18. The stationary photo sensor 18 mounted to the external frame is located on plane with these outwardly disposed inspection ports in the canister. Sensor 18 is positioned so that the presence or absence of a sleeve in an individual canister is determined immediately prior to position of the canister from which a sleeve can drop from the canister into the mixing tank 19. The sensor indicates the presence or absence of a sleeve 2 within an individual canister 15.

When the machine is operating and the finished product tank 9 located below the mixing tank in one embodiment indicates a demand for additional mixed product, the machine verifies by means of the photo sensor 18 that the canister in the canister drum 6 that is immediately next to the opening 16 in the lower plate 12 that a sleeve 2 is present in that canister. The canister drum 6 is actuated to rotate until a canister 15 having a sleeve of cleaning product is positioned above the opening 16 in the canister base or lower plate 12. Rotation of the canister drum stops in position for the sleeve 2 to gravitationally drop through the opening and into mixing tank 19 below.

In a preferred embodiment, after a sleeve 2 drops into the currently dry mixing tank 19, water is added to the proper fill level in the mixing tank 19. In another embodiment, the sleeve may drop into a mixing tank filled or partially filled with water. Filling of water may be controlled by a water solenoid valve that may have a garden hose type connection 20 to a water source. The water level is controlled by a level sensor 28 in the mixing tank, thereby insuring an accurate concentration of mixed product. In some useful embodiments of operation, water may be added to the mixing tank prior to the addition of the sleeves 2.

Preferably after a predetermined wait period that gives the soluble sleeve wrapper time to dissolve or partially dissolve, a propeller 21 driven by the mixing motor 22 is actuated in the mixing tank and runs for a predetermined period of time. The mixing motor runs for a time calculated to complete dissolution of the solid cleaning product in the water, thereby insuring a completely mixed and proper strength cleaning solution.

After mixing is complete, the drain valve 23 in the mixing tank opens and the mixed finished product is transferred into the finished product holding tank 9. After the mixing tank is empty and the level sensor 8 in the finished product holding tank acknowledges completed transfer of the finished product, the drain valve 23 closes.

The canister drum 6 rotates and drops another sleeve 2 to be mixed with water when usage of finished product causes a level drop in the finished product holding tank that is below the activation point of the level sensor 8.

Finished product is removed from the holding tank as needed by associated cleaning equipment, such as by a “pickup stick” pipe 24 inserted into the finished product holding tank 9.

If the next canister in line to drop a sleeve into the mixing tank does not contain a sleeve as determined by the photo sensor 18, the machine rotates the next individual canister in the drum to the position for review by the photo sensor. If this canister is empty as well, rotation of the canister barrel continues until a filled canister is located. If none of the individual canisters contains a sleeve, as determined in one embodiment by a counter that counts the number of canisters that have rotated past the photo sensor, a warning signal such as light 25 is actuated indicating a need to refill the machine.

Other level sensors 26 in the finished product holding tank 9 may sound an audible device and/or visual indicator (such as a colored alarm light) should the cleaning solution in the finished product holding tank 9 drop below a required level. Electronic communications such as a cell phone or a computer may also be used to indicate a need for loading additional sleeves or to indicate machine malfunctions.

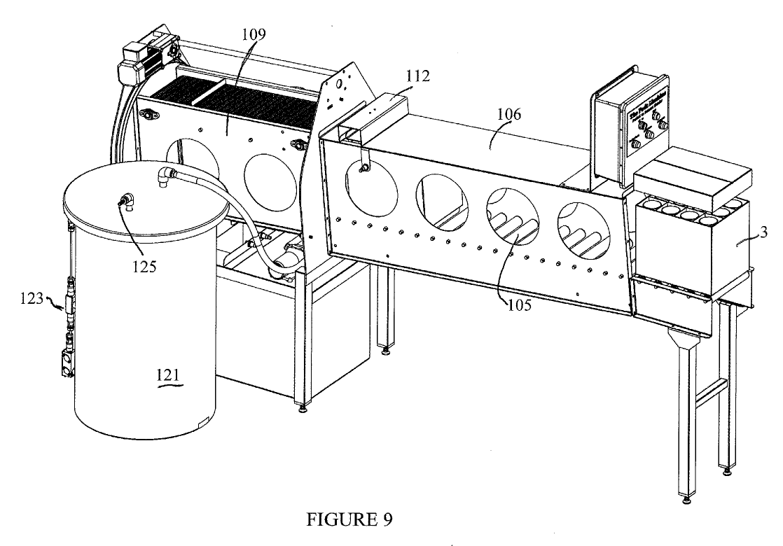

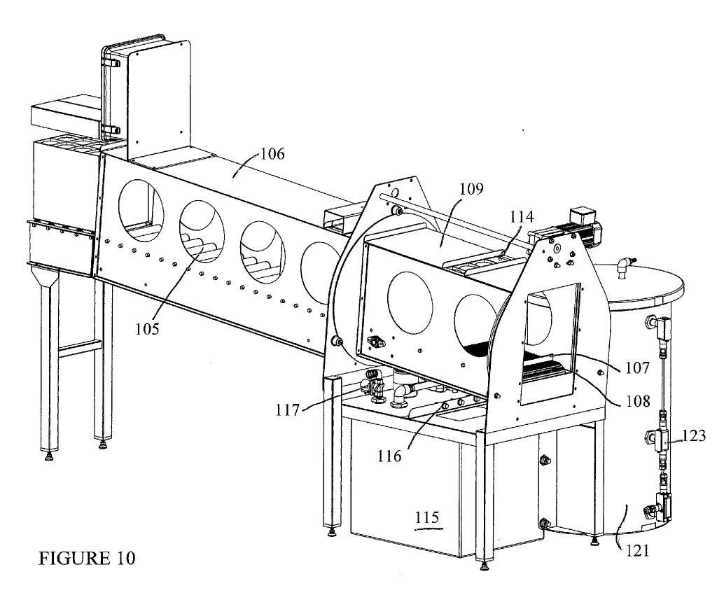

C. The Machine. Another embodiment is shown in FIGS. 9-15. A machine operator places a plurality of boxes 3 on the machine's conveyor 105, which may be a gravity fed roller conveyor. The machine operator removes lid 4 and positions the box on the rollers of the gravity feed section 106 of the machine.

In a preferred embodiment, the width and height of the gravity feed section of the machine is designed so that the boxes can enter this section only if the box is oriented lengthwise and with the lid removed.

Forward progress of the boxes 3 is halted at the end of the gravity feed section by a vertical vane, such as vertical vane 107. The motor driven belt conveyor 108 in the rotator section 109 of the machine may comprise a plurality of vertical vanes that control movement of the box. When the machine detects the presence of a box at the end of the gravity feed section, but no box is in the rotator section 109, the motor driven belt conveyor 108 moves a box from the gravity feed conveyor into the rotator section. Before the entirety of the box moves into the rotator section, a holding brake 112 near the end of the gravity feed section is actuated to hold the next box in the gravity feed conveyor queue.

In one embodiment, brake 112 is spring biased pad that may be approximately the width of the box 3. If no box is detected by a detection device, which may be a photo sensor, in the gravity feed area 106, the brake retracts upwardly and allows passage of a box into the rotator section 109. The brake remains in an upward retracted state until a box enters the rotator section and the box is moved forward by the conveyor belt 108 to a position where only the rearward most section of the box of sleeves 111 of sleeves remains in the gravity feed area 106. If another box of sleeves 110 is behind the box 111, as detected by a sensor, after box 111 enters the rotator section the holding brake releases and presses downwardly on box 110 to prevent further forward motion of box 110. The brake prevents box 110 from entering rotator section and interfering with its operation and rotation.

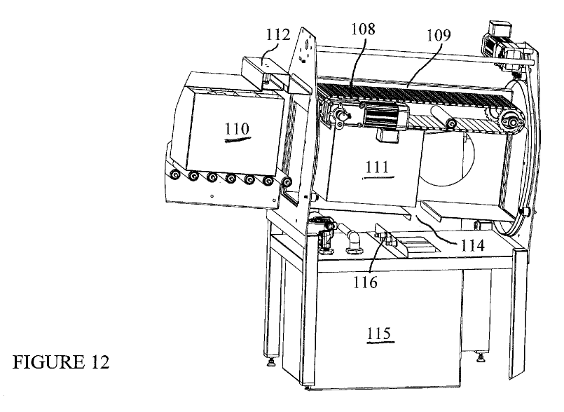

When the first box is completely positioned in the rotator section of the machine the motor driven belt conveyor 108 stops. The rotator section 109 then rotates 180 degrees about its long axis to invert the box. FIG. 12.

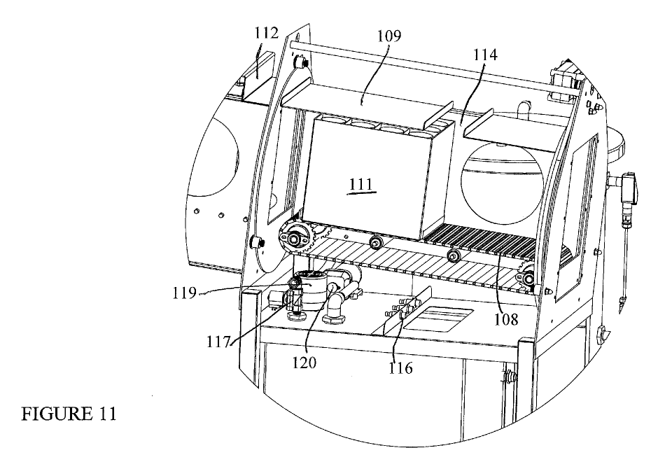

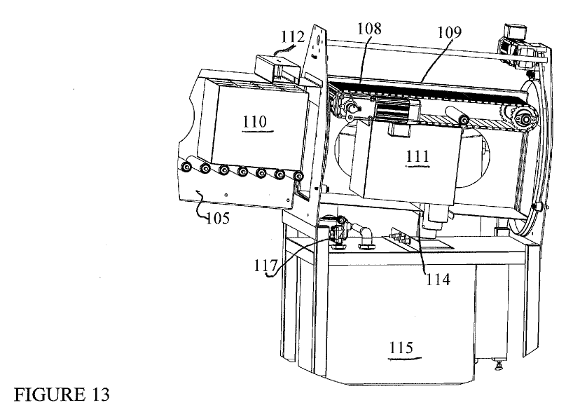

After the box of sleeves 111 enters into the rotator section of the machine and the box resides completely within the rotator section, the motor driven conveyor belt 108 advances the box in stages that correspond to the number of rows of sleeves in the box. By way of example, a vertical vane 107 of the conveyor belt pushes box 111 forward and in the direction of the exit of the machine. A slot 114 is located in what is shown as the top of the rotator section in FIG. 11, but becomes the bottom of the rotator section after rotation. The slot is about the width and length of one row of the partitions in the box 111 to allow passage of one row of sleeves through the slot. As shown in the embodiment of the illustrations, one row of the box is three (3) sleeves. When the first row of three sleeves is positioned over the slot 114, the motor driven conveyor 108 stops and the row of sleeves 2 located over the now exposed slot drops by gravity into the mixing tank 115 located below the rotator section 109. FIG. 13.

Sensors 116 located in the fall line of the sleeves ensure that sleeves are not absent and that no sleeve has become jammed or is stuck in the box. Should this situation occur, information may be provided by audible devices and alarm lights, or by connection to a computer or a mobile telephone.

After the row of sleeves drops into the preferably empty or mostly empty mixing tank, water is automatically added. In one embodiment, a solenoid actuated valve 117 allows water to enter the mixing tank. Water flow is terminated by the valve when the proper fill level in the mixing tank is reached. The water level may be controlled by a level sensor in the mixing tank, thereby insuring an accurate mix according to the required concentration of cleaning product. In some useful embodiments of operation, water may be added to the mixing tank prior to the addition of the sleeves 2 of solid cleaning product.

Preferably there is a waiting period before agitation while the water-soluble sleeve wrapper begins to dissolve. Agitation may be supplied by a propeller that is driven by a mixing motor 119. Agitation within the mixing tank occurs for a predetermined period of time as necessary to completely dissolve the solid cleaning product in the water and provide a completely mixed cleaning solution.

After mixing is complete a transfer pump 120 is actuated by the machine. The transfer pump evacuates the finished cleaning solution to a finished product holding tank 121.

Level sensors in the mixing tank 115 communicate with the transfer pump when the mixing tank is empty. Operation of the transfer pump 120 is terminated.

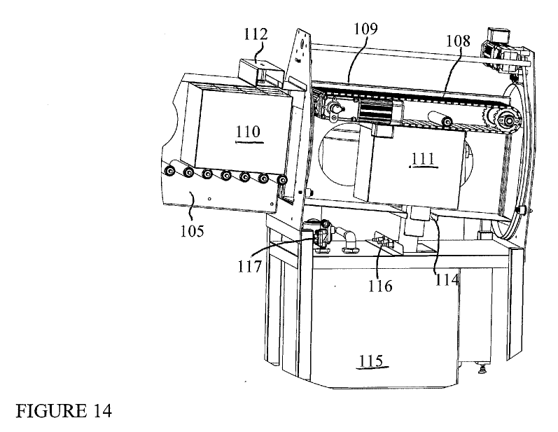

Finished cleaning product is removed from the holding tank 121 as required by the user. A “pickup stick” pipe 125 may be inserted into the finished product holding tank 121. A level sensor 123 in the finished product holding tank tells the machine when more product is needed. Vertical vanes on the belt driven conveyor 108 then advance the box within the rotator section 111 to position the next row of sleeves over the drop area opening or slot 114. FIG. 14. The process is repeated based upon the number of rows of sleeves, which in the embodiment of box 3 shown in the drawings is four.

Additional level sensors 123 in the finished product holding tank 121 may be used to inform the customer should the cleaning solution in the finished product holding tank 121 run too low or too high. Such information may be provided by audible devices and alarm lights, or by connection to a computer or a mobile telephone.

When the amount of cleaning solution in the mixing tank is reduced to a predetermined level, the motor driven conveyor 108 moves the box until a row of sleeves 2 located over the exposed slot 114 drop into the mixing tank 115 located below the rotator section 109. This process is continued until the box is emptied of sleeves.

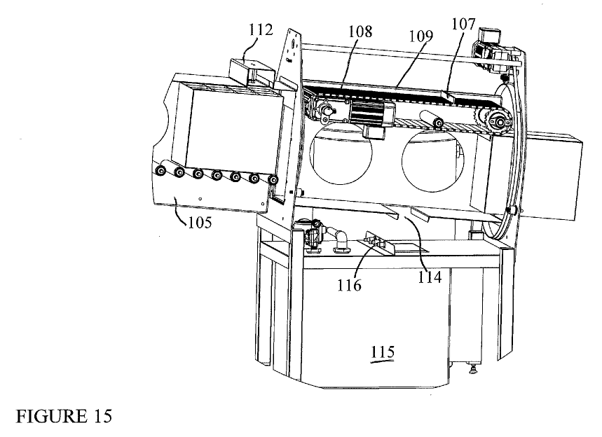

After the box 111 has been emptied of sleeves, the belt driven conveyor 108 pushes the empty box 111 from end of the rotator 109. FIG. 15. The rotator section 109 rotates back to its box receiving position. The next box in the queue is advanced into the rotator section as described herein, and the box is progressively advanced within the rotated rotator section to supply sleeves for mixing as described until the box is empty.

A sensor such as a photo sensor on the gravity feed section of the conveyor 106 may cause a warning light to flash and/or an audible alarm to sound when the last box in the conveyor gravity feed queue has passed into the rotator section. The operator is alerted to reload the gravity feed conveyor 106 with filled boxes.

The systems as described provide liquid cleaner without requiring water or hazardous materials to be shipped. By way of example, a 45 lb. (20.5 kg) non-hazardous box makes the equivalent of 100 gallons of cleaning product by using water that is available at virtually all end user sites, replacing two 55 gallon drums that may weigh 1,000 pounds. The machine as described may hold 5 boxes of sleeves or more. Five (5) boxes may make 500 gallons of cleaning product. The system described eliminates handling of heavy drums of liquid cleaning product. In most applications, the system will substantially reduce the labor required to employ cleaning product.

What is claimed is:

1. A device for processing solid cleaning product into solution, comprising:
a drum comprising a plurality of canisters each having a top opening and a lower opening;
a plate positioned below the drum the plate having an orifice therein, wherein the drum and lower plate are in a rotational relationship to progressively align the lower opening of each canister with the orifice in the plate; and
a mixing tank positioned below the drum that communicates with the drum and receives a sleeve of solid cleaning product gravitationally transported from a canister of the plurality of canisters through the orifice of the lower plate.

2. A device for processing solid cleaning product into solution as described in claim 1, further comprising an upper plate positioned above the drum, the upper plate comprising a plurality of orifices, wherein each orifice of the upper plate aligns with a top opening of one of the canisters of the plurality of canisters.

3. A device for processing solid cleaning product into solution as described in claim 1, further comprising an upper plate positioned above the drum, the upper plate comprising a plurality of orifices, wherein each orifice of the upper plate aligns with a top opening of one of the canisters of the plurality of canisters, wherein the upper plate has one less orifice than the number of canisters of the plurality of canisters, and wherein none of the orifices of the upper plate are positioned directly above the orifice of the lower plate.

4. A device for processing solid cleaning product into solution as described in claim 1, wherein each of the canisters of the plurality of canisters comprises an inspection port, and further comprising a photo sensor that communicates with the inspection port.

5. A device for processing solid cleaning product into solution as described in claim 1, wherein each of the canisters of the plurality of canisters comprises an inspection port, and further comprising a photo sensor that communicates with the inspection port, and wherein the photo sensor actuates rotation of the drum relative to the lower plate to position a canister containing a sleeve of cleaning product over the orifice in the lower plate to gravitationally transport the solid cleaning product from the canister through the orifice of the lower plate.

6. A device for processing solid cleaning product into solution as described in claim 1, wherein each of the canisters of the plurality of canisters comprises an inspection port, and further comprising a photo sensor that communicates with the inspection port, and wherein the photo sensor senses a presence or absence of a sleeve of solid cleaning product in the canister and actuates rotation of the drum relative to the lower plate to position a canister containing a sleeve of cleaning product over the orifice in the lower plate to gravitationally transport the solid cleaning product from the canister through the orifice of the lower plate, and wherein if rotation is equal to or exceeds one revolution without detection of solid cleaning product in a canister, a warning signal is actuated.

7. A device for processing solid cleaning product into solution as described in claim 1, further comprising a counter that counts the number of canisters that have moved over the orifice in the lower plate, and actuates a warning signal upon a predetermined number of canisters that have moved over the orifice in the lower plate.

8. A device for processing solid cleaning product into solution as described in claim 1, wherein the solid cleaning product is contained in a water soluble sleeve.

9. A device for processing solid cleaning product into solution as described in claim 1, further comprising a product holding tank positioned below the mixing tank.

10. A device for processing solid cleaning product into solution as described in claim 1, further comprising a product holding tank, wherein the product comprises a water level sensor, and wherein the water level sensor actuates filling of the mixing tank with water and actuates the rotational relationship of the drum relative and lower plate to actuate depositing a sleeve of solid cleaning product into the mixing tank.

11. A device for processing solid cleaning product into solution as described in claim 1, wherein the drum rotates and the lower plate is static relative to the drum.

12. A device for processing solid cleaning product into solution as described in claim 2, wherein the drum rotates and the lower plate and upper plate are static relative to the drum.

13. A device for processing solid cleaning product into solution as described in claim 1, wherein the solid cleaning product is formed as a plurality of disks, and the disks are contained in a water soluble sleeve.

14. A device for processing solid cleaning product into solution as described in claim 1, wherein the solid cleaning product is formed as a powder, and the powder is contained in a water soluble sleeve.
